(19) United States
(12) Patent Application Publication
(10) Pub. No.: US 2016/0092726 A1
(43) Pub. Date: Mar. 31, 2016

(54) USING GESTURES TO TRAIN HAND DETECTION IN EGO-CENTRIC VIDEO

(71) Applicant: Xerox Corporation, Norwalk, CT (US)

(72) Inventors: QUN LI, Webster, NY (US); Jayant Kumar, Webster, NY (US); Edgar A. Bernal, Webster, NY (US); Raja Bala, Pittsford, NY (US)

(21) Appl. No.: 14/501,250

(22) Filed: Sep. 30, 2014

(51) Int. Cl. G06K 9/00; G02B 27/01; G06F 3/01

(52) U.S. Cl. CPC G06K 9/00355; G06F 3/017; G02B 27/017

(57) ABSTRACT

A method, non-transitory computer readable medium, and apparatus for training hand detection in an ego-centric video are disclosed. For example, the method prompts a user to provide a hand gesture, captures the ego-centric video containing the hand gesture, analyzes the hand gesture in a frame of the ego-centric video to identify a set of pixels in the image corresponding to a hand region, generates a training set of features from the set of pixels that correspond to the hand region and trains a head-mounted video device to detect the hand in subsequently captured ego-centric video images based on the training set of features.

The present disclosure relates generally to training head-mounted video devices to detect hands and, more particularly, to a method and apparatus for using gestures to train hand detection in ego-centric video.

### BACKGROUND

Wearable devices are being introduced by various companies and are becoming more popular in what the wearable devices can do. One example of a wearable device is a head-mounted video device, such as for example, Google Glass®.

A critical capability with wearable devices, such as the head-mounted video device, is detecting a user's hand or hands in real-time as a given activity is proceeding. Current methods require analysis of thousands of training images and manual labeling of hand pixels within the training images. This is a very laborious and inefficient process.

In addition, the current methods are general and can lead to inaccurate detection of a user's hand. For example, different people have different colored hands. As a result, the current methods may try to capture a wider range of hand colors, which may lead to more errors in hand detection. Even for the same user, as the user moves to a different environment the current methods may fail due to variations in apparent hand color across different environmental conditions. Also, the current methods may have difficulty detecting a user's hand, or portions thereof, if the user wears anything on his or her hands (e.g., gloves, rings, tattoos, etc.).

### SUMMARY

According to aspects illustrated herein, there are provided a method, a non-transitory computer readable medium, and an apparatus for training hand detection in an ego-centric video. One disclosed feature of the embodiments is a method that prompts a user to provide a hand gesture, captures the ego-centric video containing the hand gesture, analyzes the hand gesture in a frame of the ego-centric video to identify a set of pixels in the image corresponding to a hand region, generates a training set of features from the set of pixels that correspond to the hand region and trains a head-mounted video device to detect the hand in subsequently captured ego-centric video images based on the training set of features.

Another disclosed feature of the embodiments is a non-transitory computer-readable medium having stored thereon a plurality of instructions, the plurality of instructions including instructions which, when executed by a processor, cause the processor to perform an operation that prompts a user to provide a hand gesture, captures the ego-centric video containing the hand gesture, analyzes the hand gesture in a frame of the ego-centric video to identify a set of pixels in the image corresponding to a hand region, generates a training set of features from the set of pixels that correspond to the hand region and trains a head-mounted video device to detect the hand in subsequently captured ego-centric video images based on the training set of features.

Another disclosed feature of the embodiments is an apparatus comprising a processor and a computer readable medium storing a plurality of instructions which, when executed by the processor, cause the processor to perform an operation that prompts a user to provide a hand gesture, captures the ego-centric video containing the hand gesture, analyzes the hand gesture in a frame of the ego-centric video to identify a set of pixels in the image corresponding to a hand region, generates a training set of features from the set of pixels that correspond to the hand region and trains a head-mounted video device to detect the hand in subsequently captured ego-centric video images based on the training set of features.

### BRIEF DESCRIPTION OF THE DRAWINGS

The teaching of the present disclosure can be readily understood by considering the following detailed description in conjunction with the accompanying drawings, in which:

FIG. 1 illustrates an example block diagram of head-mounted video device of the present disclosure;

FIG. 2A-2C illustrate examples of hand gestures captured for training hand detection of the head-mounted video device;

FIG. 3 illustrates an example of a motion vector field plot;

FIG. 4 illustrates an example of a region-growing algorithm applied to a seed pixel to generate a binary mask;

FIG. 5 illustrates an example flowchart of one embodiment of a method for training hand detection in an ego-centric video; and

FIG. 6 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer-readable medium and an apparatus for training hand detection in an ego-centric video. Current methods for training head-mounted video devices to detect hands are a manual process that is laborious and inefficient. The current method requires an individual to manually examine thousands of images and manually label each pixel in the image as a hand pixel.

Embodiments of the present disclosure provide a more efficient process that may be used to train the head-mounted video device for hand detection in real-time. In addition, the training is personalized by using the hand of the individual wearing the head-mounted video device in a specific environment. As a result, the hand detection process is more accurate.

In addition, due to the efficient nature of the hand detection training disclosed in the present disclosure, the training may be performed each time the individual enters a new environment. For example, the apparent color of an individual's hand on an image may change as the lighting changes (e.g., moving from indoors to outdoors). In addition, the embodiments of the present disclosure may train the head-mounted video device to detect the user's hands when the user is wearing an accessory on his or her hands (e.g., gloves, a cast, and the like).

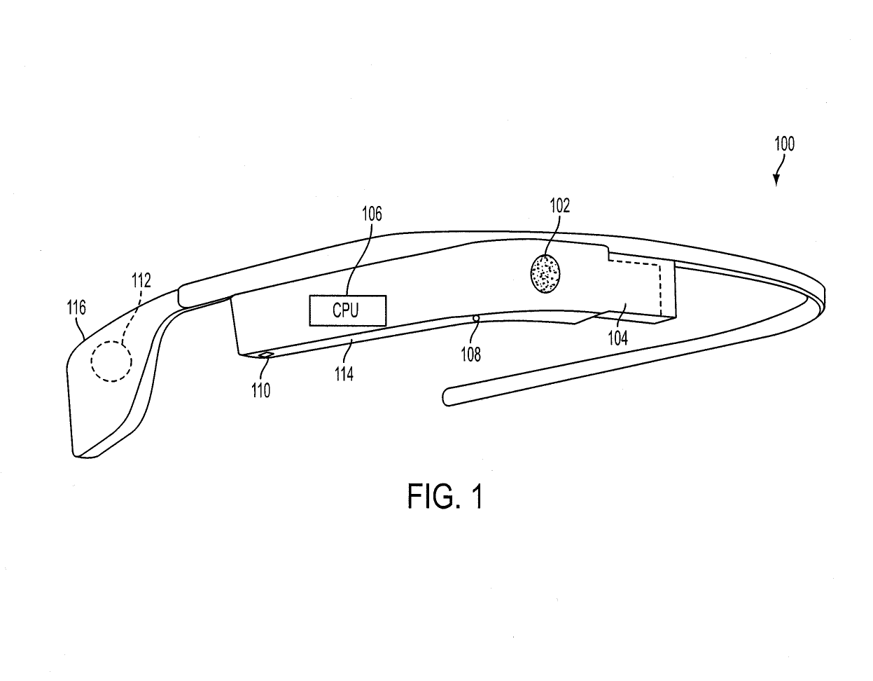

FIG. 1 illustrates an example of a head-mounted video device 100 of the present disclosure. In one embodiment, the head-mounted video device 100 may be a device, for example, Google Glass®. In one embodiment, the head-mounted video device 100 may include a camera 102, a display 104, a processor 106, a microphone 108, one or more speakers 110 and a battery 112. In one embodiment, the processor 106, the camera microphone 108 and the one or more speakers 110 may be inside of or built into a housing 114. In one embodiment, the battery 112 may be inside of an arm 116.

It should be noted that FIG. 1 illustrates a simplified figure of the head-mounted video device 100. The head-mounted video device 100 may include other modules not show, such as for example, a global positioning system (GPS) module, a memory, and the like.

In one embodiment, the camera 102 may be used to capture ego-centric video. In one embodiment, ego-centric video may be defined as video that is captured from a perspective of a user wearing the head-mounted video device 100. In other words, the ego-centric video is a view of what the user is also looking at.

In one embodiment, commands for the head-mounted video device 100 may be based on hand gestures. For example, a user may initiate commands to instruct the head-mounted video device to perform an action or function by performing a hand gesture in front of the camera 102 that is also shown by the display 104. However, before the hand gestures can be used to perform commands, the head-mounted video device 100 must be trained to recognize the hands of the user captured by the camera 102.

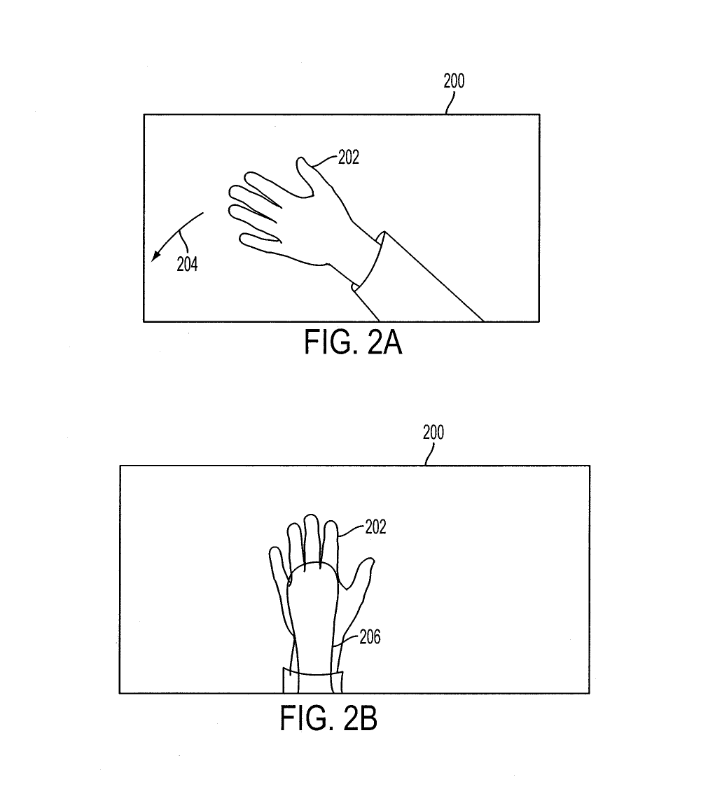

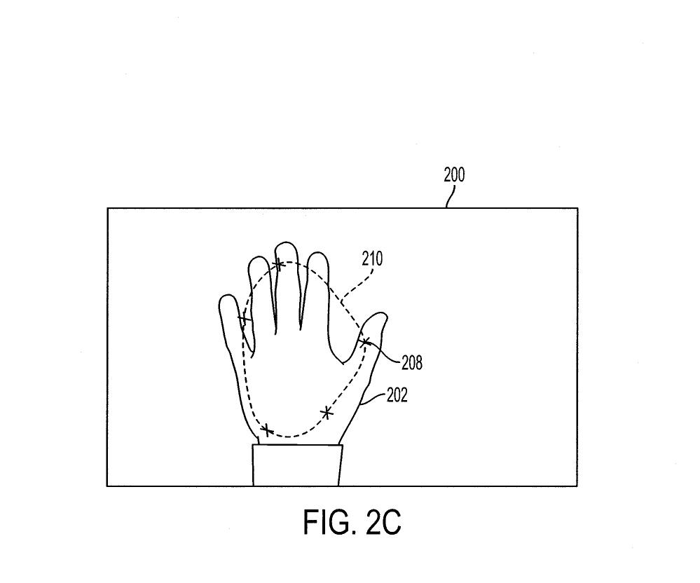

FIGS. 2A-2C illustrate examples of hand gestures that can be used to initiate training of the head-mounted video device 100. In one embodiment, the user wearing the head-mounted video device 100 may be prompted to perform a particular hand gesture to initiate the training.

In one embodiment, a hand wave may be used as illustrated in FIG. 2A. For example, a user may be prompted to wave his or her hand 202 in front of the camera 102. In one embodiment, a message may be displayed on the display 104 indicating that the camera 102 is waiting for a hand gesture.

In one embodiment, the hand gesture may be a hand wave. For example, the hand 202 may be waved from right to left as indicated by arrow 204. In one embodiment, a front and a back of the hand 202 may be waved in front of the camera 102. For example, the front of the hand 202 may be waved from right to left and then the back of the hand may be waved from left to right. In one embodiment, capturing ego-centric video of both the front of the hand and the back of the hand provides a more accurate hand detection as the color of the front of the hand and the back of the hand may be different.

In another embodiment, the user may be prompted to place his or her hand 202 in an overlay region 206, as illustrated in FIG. 2B. In one embodiment, the overlay region 206 may be displayed to the user via the display 104. The user may place his or her hand 202 in front of the camera 102 such that the hand 202 is within the overlay region 206. For example, the user may use the overlay region 206 displayed in the display 104 to guide his or her hand 202 properly.

In another embodiment, the user may be prompted to move a marker 208 over or around his or her hand 202 by moving the camera 102, as illustrated in FIG. 2C. For example, a marker 208 may be displayed on the display 104 and the user may move his or her head around his or her hand 202 to “trace” or “color” in the hand 202.

By prompting the user to perform a hand gesture, the head-mounted video device 100 may be able to obtain a seed pixel that can be used to generate a binary mask that indicates likely locations of hand pixels in the acquired ego-centric video. For example, in FIGS. 2B and 2C, a seed pixel may be assumed to be pixels within the overlay region 206 of FIG. 2B or within an area traced by the marker 208 as illustrated in FIG. 2C.

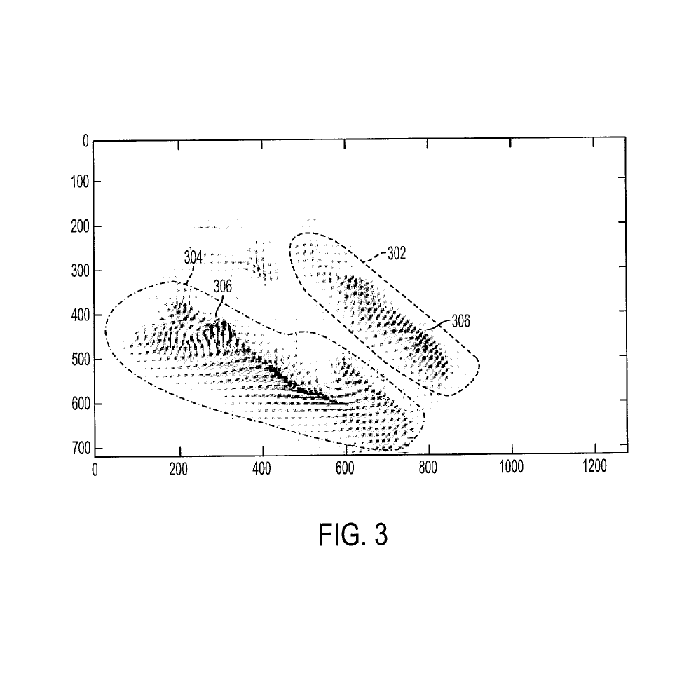

In another example, referring to the hand wave illustrated in FIG. 2A, the head-mounted device 100 may perform an optical-flow algorithm (e.g., Horn-Schunck, Lucas-Kanade or Brown optical flow) to capture motion between two consecutive selected frames. Using the two selected frames, a motion vector field may be generated; a corresponding motion vector field plot 300 is illustrated in FIG. 3. Typically in ego-centric video, the foreground motion (e.g., the hand waving gesture) is more significant compared to the background motion. Thus, optical-flow algorithms may be employed for foreground motion segmentation. Other motion detection and analysis algorithms may also be used. For example, other motion detection and analysis algorithms may include temporal frame differencing algorithms, and the like.

In one embodiment, the motion vector field plot 300 may include vectors 306 that represent a direction and magnitude of motion based on the comparison of the two consecutive selected frames. In one embodiment, thresholding in the magnitude of the motion vector field may be used to identify pixels within the ego-centric video images that are likely to be hand pixels. The threshold for the magnitude of motion may be pre-defined or may be dynamically chosen based on a histogram of motion vector magnitudes of ego-centric video images.

In one embodiment, multiple sets of two consecutive selected frames may be analyzed. For example, if 100 frames of ego-centric video images are captured during the hand gesture, then up to 99 pairs of consecutive frames may be analyzed. However, not all 99 pairs of consecutive frames may be analyzed. For example, every other pair of consecutive frames, every fifth pair of consecutive frames, and so on, may be analyzed based upon a particular application. In another embodiment, pairs of non-consecutive frames may be analyzed.

Based on the thresholding of the vectors 306, the pixels that are potentially hand pixels may be identified within the outlined regions 302 and 304. However, performing the thresholding on motion vector field plot 300 obtained from the optical flow algorithm may not be accurate enough segmentation of the hand region. Thus, a pixel associated with a vector 306 within one of the regions 302 and 304 may be selected as a seed pixel and a region-growing algorithm may be applied to generate a binary mask that provides a better segmentation of the hand 202. In one embodiment, more than one pixel may be selected as seed pixels and the region-growing algorithm may be applied to multiple seed pixels. In one embodiment, a small region of a plurality of pixels may be selected as the seed pixel.

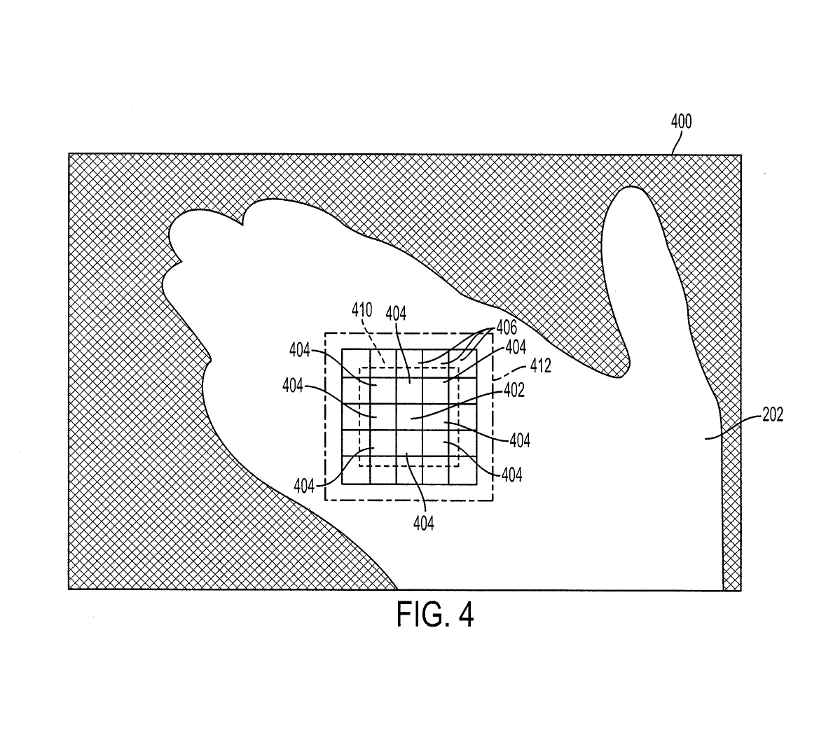

FIG. 4 illustrates one example of the region-growing algorithm applied to a seed pixel 402. For example, the seed pixel 402 may be a pixel associated with a vector 306 in the area 304 of the motion vector field plot 300 illustrated in FIG. 3. In one embodiment, the region-growing algorithm may select a region 410 that includes one or more neighboring pixels 404. A characteristic of the neighboring pixel 404 may be compared to the seed pixel 402 to determine if a feature of the characteristic that is used matches or is within an acceptable value range of the feature of the seed pixel 402. The type of characteristic and associated features used to make region-growing decisions may depend on the choice of feature space.

Then, a larger region 412 may be selected to include additional neighboring pixels 406. The additional neighboring pixels 406 may be compared to the neighboring pixels 404 that are within an acceptable range of the feature of seed pixel 402 to determine if the feature or features matches or is within a given range of the feature or features of the neighboring pixels 404. The process may be repeated by selecting additional larger regions until the pixels neighboring previously selected regions do not match the characteristics of the previously selected regions. When the region-growing algorithm is completed an accurate segmentation of the hand 202 in FIGS. 2A and 3 is shown in FIG. 4 as a binary mask.

In one embodiment, the characteristic may be a feature or features in a color space represented by an n-dimensional vector. A common example is a three-dimensional color space (e.g., red green blue (RGB) color space, a LAB color space, a hue saturation value (HSV) color space, a YUV color space, LUV color space or a YCbCr color space). In one embodiment, the characteristic may include a plurality of different features in addition to color, such as for example, brightness, hue, texture, and the like. In one embodiment, when color is the characteristic that is compared for the region-growing algorithm, the region-growing algorithm may be performed by looking for color similarity in the n-dimensional color space. This can be accomplished by computing an n-dimensional distance between the n-dimensional vector of each one of the two pixels and checking if this is smaller than a pre-defined threshold. If the color space is, for example, in a red green blue (RGB) color space, then the color similarity may be obtained by computing Euclidean distance between two three-dimensional RGB vectors. Distance metrics other than the Euclidean can be used, for example, the Mahalanobis, or L₀/L₁ norms of the difference vectors or inner product can also be used. The output is a binary mask which distinguishes pixels belonging to hand regions versus pixels not belonging to hand regions.

In one embodiment, based on the binary mask that identifies the hand pixels, the value of the hand pixels may then be used to train a hand detector for identifying hand pixels or a hand in subsequent ego-centric videos that are captured. In the first step of hand detection training, all hand region pixels are collected. Next, features are derived from the pixel values. Note that these features need not necessarily be the same features used in the previous region growing step. Examples of features used for hand detection include a 3-dimensional color representation such as RGB, LAB, YCbCR; a 1-dimensional luminance representation, multi-dimensional texture features, or combinations of color and texture. In one embodiment, if the RGB color is used as the feature, a probability distribution of the RGB color values of the hand region pixels from each of the frames capturing the hand gesture may be modeled via a Gaussian mixture model. The known distribution of RGB color values for the hand pixels may be then used to determine if a pixel in the subsequent ego-centric videos that are captured is part of a hand. This determination is made, for example, by performing a fit test which determines the likelihood that a given pixel value in a subsequent video frame belongs to its corresponding mixture model: if the likelihood is high, then a decision can be made with high confidence that the pixel belongs to a hand, and vice-versa. In an alternative embodiment, other parametric and non-parametric methods for probability density estimation may be used to model the pixels in hand regions, and fit tests performed on the estimated densities to determine whether pixels in subsequent video frames are part of a hand.

In yet another embodiment, features are computed of pixels belonging to hand and non-hand regions, and a classifier is trained to differentiate between the two pixel classes. According to this embodiment, using the binary mask, features from hand regions are assigned to one class, and features of pixels not in the hand regions are assigned to another class. The two sets of features are then fed to a classifier that is trained to distinguish hand from non-hand pixels in the feature descriptor space. The trained classifier may then be used to detect the hand in subsequently captured ego-centric video images. In one embodiment, the classifier may be a support vector machine (SVM) classifier, a distance-based classifier, a neural network, a decision tree, and the like.

It should be noted that the training methods disclosed by the embodiments described herein are automated. In other words, the training methods of the embodiments of the present disclosure do not require manual labeling by an individual for each one of thousands of images. It should also be noted that the same set of features used for training should also be used in subsequent detection steps.

In addition, the training models disclosed herein are performed efficiently and quickly and, thus, can be used whenever the user enters a new environment or wears an accessory on his or her hand. For example, the appearance of the apparent color of a user's hand captured by the camera 102 or on a display 104 may change in different lighting (e.g., moving from one room to another room with brighter lighting, moving from an indoor location to an outdoor location, using the head-mounted video device during the day versus during the evening, and the like). Thus, as the environment changes, the training may be performed to calibrate the hand detection to be specific to the current environment.

Furthermore, when a user wears gloves or has a cast on his or her hand, or other accessories such as rings, bracelets or tattoos, the training methods disclosed herein can be used to still detect the user's hand based on the color of the accessory used during the training. In contrast, previous general training models approximated skin color and would be unable to detect hands when a user wears gloves with colors that are outside of the range of skin tone colors.

In addition, the training is personalized for each user. As a result, the hand detection in subsequent ego-centric video that is captured is more accurate than generalized training models that were previously used. Thus, the embodiments of the present disclosure provide a method for using hand gestures to train a head-mounted video device for hand detection automatically that is more efficient and accurate than previously used hand detection training methods.

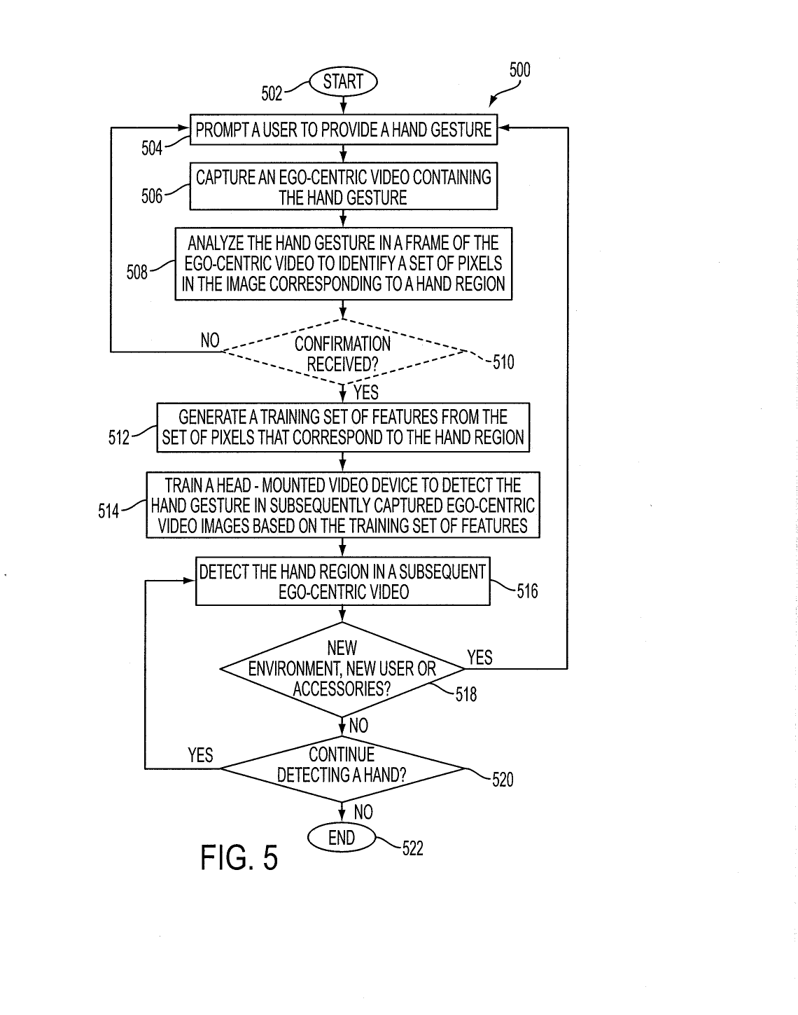

FIG. 5 illustrates a flowchart of a method 500 for training hand detection in an ego-centric video. In one embodiment, one or more steps or operations of the method 500 may be performed by the head-mounted video device 100 or a general-purpose computer as illustrated in FIG. 5 and discussed below. In one embodiment, steps 502-512 may be referred to collectively as the hand detection training steps that may be applied to the subsequent hand detection referred to in steps 514-520, as discussed below.

At step 502 the method 500 begins. At step 504, the method 500 prompts a user to provide a hand gesture. For example, a user wearing the head-mounted video device may be prompted via a display on the head-mounted video device to perform a hand gesture. A camera on the head-mounted video device may capture an ego-centric video of the hand gesture that can be used to train the head-mounted video device for hand detection.

At step 506, the method 500 captures an ego-centric video containing the hand gesture. In one embodiment, the hand gesture may include waving the user's hand in front of the camera. For example, the user may wave the front of the hand in front of the camera in one direction and wave the back of the hand in front of the camera in an opposite direction while the camera captures the ego-centric video.

In another embodiment, the user may be prompted to place his or her hand in an overlay region that is shown in the display. For example, the overlay region may be an outline of a hand and the user may be asked to place his or her hand to cover the overlay region while the camera captures the ego-centric video.

In another embodiment, the user may be prompted to move a marker (e.g., a crosshair, point, arrow, and the like) over and/or around his or her hand. For example, the user may raise his or her hand in front of the camera so it appears in the display and move his or her head to move the camera around his or her hand. For example, the user may “trace” his or her hand with the marker or “color in” his or her hand with the marker while the camera captures the ego-centric video.

At step 508, the method 500 analyzes the hand gesture in a frame of the ego-centric video to identify a set of pixels in the image corresponding to a hand region. In one embodiment, the analysis of the hand gesture may include identifying a seed pixel from the frame of the ego-centric video using an optical-flow algorithm and a region-growing algorithm.

For example, using the hand waving motion example above, the seed pixel may be generated by using an optical-flow algorithm to capture motion between two consecutive selected frames and using thresholding on the magnitude of a motion vector field plot created from the optical-flow algorithm. In another embodiment, the seed pixel may be assumed to be a pixel within the overlay region or within an area “traced” or “colored in” by the user with the camera.

Then a binary mask of a hand may be generated using a region-growing algorithm that is applied to the seed pixel. The binary mask of the hand may provide an accurate segmentation of hand pixels such that the hand pixels may be identified and then characterized. A detailed description of the region-growing algorithm is described above.

At optional step 510, the method 500 may determine if a confirmation is received that the hand region was correctly detected in a verification step. For example, a display may show an outline overlay around an area of the frame that is believed to be the hand region to the user. The user may either confirm that the outline overlay is correctly around the hand region or provide an input (e.g., voice command) indicating that the outline overlay is not around the hand region.

In one embodiment, if the confirmation is not received at step 510, the method 500 may return to step 504 to repeat the hand detection training steps 504-508. However, if the confirmation is received at step 510, the method 500 may proceed to step 512. In another embodiment, if the confirmation is not received at step 510, the method 500 may return to step 508 and perform analysis of hand gestures with different algorithm parameters or a different algorithm altogether.

At step 512, the method 500 generates a training set of features from the set of pixels that correspond to the hand region. For example, the features may be a characteristic used to perform the region-growing algorithm. In one embodiment, the feature may be in a color space. For example, the color space may be in the RGB color space and the hand pixels may be characterized based on a known distribution of RGB color values of the hand pixels. In alternative embodiments, the features may be features descriptive of texture, or features descriptive of saliency, including local binary patterns (LBP), histograms of gradients (HOG), maximally stable extremal regions (MSER), successive mean quantization transform (SMQT) features, and the like.

At step 514, the method 500 trains a head-mounted video device to detect the hand gesture in subsequently captured ego-centric video images based on the training set of features. For example, the training set of features may be the known distribution of RGB color values for hand pixels in the hand region. The head-mounted video device may then use the known distribution of RGB color values to determine if pixels in subsequently captured ego-centric videos are hand pixels within a hand region.

For example, when color is used, once the hand pixels in the hand region are identified in the binary mask after the region-growing algorithm is performed, the RGB color values of the hand pixels in the ego-centric video images of the hand gestured captured by the camera may be obtained. In one embodiment, a Gaussian mixture model may be applied to the values to estimate a distribution of RGB color values. A distribution of RGB color values for hand pixels may then be used to determine whether pixels in the ego-centric video frames belong to the hand. This determination is made, for example, by performing a fit test which determines the likelihood that a given pixel value in a subsequent video frame belongs to its corresponding mixture model: if the likelihood is high, then a decision can be made with high confidence that the pixel belongs to a hand, and vice-versa. In an alternative embodiment, other density estimation methods can be used, including parametric and non-parametric and fit tests performed on the estimated densities to determine whether pixels in subsequent video frames are part of a hand.

In an alternative embodiment, a classifier is derived that distinguishes hand pixels from non-hand pixels. In this embodiment, features of pixels identified with the binary mask are extracted and assigned to one class, and features of pixels not identified with the binary mask are extracted and assigned to another class. The features used in the classifier may be different than the features used in the region-growing algorithm. The two sets of features are then fed to a classifier that is trained to distinguish hand from non-hand pixels in the feature descriptor space. The trained classifier may then be used to detect the hand in subsequently captured ego-centric video images. In one embodiment, the classifier may be a support vector machine (SVM) classifier, a distance-based classifier, a neural network, a decision tree, and the like.

At step 516, the method 500 detects the hand in a subsequently ego-centric video. For example, the hand detection training may be completed and the user may begin using hand gestures to initiate commands or perform actions for the head-mounted video device. The head-mounted video device may capture ego-centric video of the user's movements.

In one embodiment, the training set of features may be applied to the subsequently captured ego-centric video to determine if any pixels within the ego-centric video images match training set of features. For example, the RGB color value of each pixel may be compared to the distribution of RGB color values for hand pixels determined in step 510 to see if there is a match or if the RGB color value falls within the range. This comparison may be performed, for example, in the form of a fit test. In other embodiments, membership tests can be used where the value of the pixel is compared to a color range determined during the training phase. The pixels that have RGB color values within the determined range of RGB color values may be identified as hand pixels in the subsequently captured ego-centric video. Alternatively, when a classifier is used, the same features used to train the classifier are extracted from pixels in subsequently captured ego-centric video, and the classifier applied to the extracted features. The classifier will then output a decision as to whether the pixels belong to hand or non-hand regions according to their feature representations.

In one embodiment, an optional confirmation step may follow step 516. For example, a display may show an outline overlay around an area of the frame that is detected in step 516 to be the hand region to the user. The user may either confirm that the outline overlay is correctly around the hand region or provide an input (e.g., voice command) indicating that the outline overlay is not around the hand region.

In one embodiment, if the confirmation is not received at this optional step, the method 500 may return to step 504 to repeat the hand detection training steps 504-508. In another embodiment, if the confirmation is not received at this optional step, the method 500 may return to step 508 and perform analysis of hand gestures with different algorithm parameters, or a different algorithm altogether. In yet another embodiment, if the confirmation is not received at this optional step, the method 500 may return to step 514 and re-train the detection algorithm. In yet another embodiment, if the confirmation is not received at this optional step, the method 500 may return to step 516, change the parameters of the detection algorithm, and perform detection again. However, if the confirmation is received at this optional step, the method 500 may proceed to step 518.

At step 518, the method 500 determines if the head-mounted video device is located in a new environment, if a new user is using the head-mounted video device or the user is wearing an accessory (e.g., gloves, jewelry, a new tattoo, and the like). For example, the user may move to a new environment with different lighting or may put on gloves. As a result, the video mounted video device may require re-training for hand detection as the color appearance of the user's hand may change due to the new environment or colored gloves or other accessory on the user's hand.

If re-training is required, the method 500 may return to step 504 and steps 504-518 may be repeated. However, if re-training is not required, the method 500 may proceed to step 520.

At step 520, the method 500 determines if hand detection should continue. For example, the user may not want to have gesture detection turned on momentarily or the head-mounted video device may be turned off. If the hand detection is still needed, the method 500 may return to step 516 to continue capturing subsequent ego-centric videos. Steps 516-520 may be repeated.

However, if hand detection is no longer needed, the method 500 may proceed to step 522. At step 522, the method 500 ends.

It should be noted that although not explicitly specified, one or more steps, functions, or operations of the method 500 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 5 that recite a determining operation, or involve a decision, do not necessarily require that both branches of the determining operation be practiced. In other words, one of the branches of the determining operation can be deemed as an optional step.

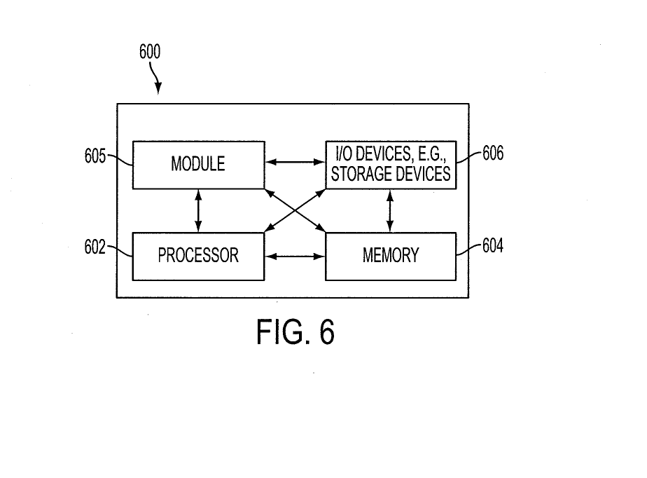

FIG. 6 depicts a high-level block diagram of a general-purpose computer suitable for use in performing the functions described herein. As depicted in FIG. 6, the system 600 comprises one or more hardware processor elements 602 (e.g., a central processing unit (CPU), a microprocessor, or a multi-core processor), a memory 604, e.g., random access memory (RAM) and/or read only memory (ROM), a module 605 for training hand detection in an ego-centric video, and various input/output devices 606 (e.g., storage devices, including but not limited to, a tape drive, a floppy drive, a hard disk drive or a compact disk drive, a receiver, a transmitter, a speaker, a display, a speech synthesizer, an output port and an input port). Although only one processor element is shown, it should be noted that the general-purpose computer may employ a plurality of processor elements.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 605 for training hand detection in an ego-centric video (e.g., a software program comprising computer-executable instructions) can be loaded into memory 604 and executed by hardware processor element 602 to implement the steps, functions or operations as discussed above in connection with the exemplary method 500. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for training hand detection in an ego-centric video (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for training hand detection in a first ego-centric video, comprising:
prompting, by a processor, a first user to provide a hand gesture, wherein the first user is wearing a head-mounted video device;
capturing, by the processor, the first ego-centric video containing the hand gesture via the head-mounted video device worn by the first user, wherein the first ego-centric video comprises a video that is captured from a perspective of the first user wearing the head-mounted video device;
analyzing, by the processor, the hand gesture in a first video frame of the first ego-centric video to identify a first set of pixels of a plurality of pixels that corresponds to a hand region in an image;
generating, by the processor, a training set of features from the first set of pixels that corresponds to the hand region; and
training, by the processor, the head-mounted video device to detect a hand in a second ego-centric video captured after the first ego-centric video based on the training set of features.

2. The method of claim 1, further comprising:
capturing, by the processor, the second ego-centric video; and
detecting, by the processor, a second set of pixels that corresponds to the hand region in the second ego-centric video based on the training set of features.

3. The method of claim 1, wherein the hand gesture comprises waving a front and a back of the hand in front of a camera of the head-mounted video device capturing the first ego-centric video.

4. The method of claim 3, wherein the analyzing the hand gesture comprises identifying a seed pixel from the first video frame of the first ego-centric video performing an optical-flow algorithm to capture a motion between two consecutive frames of the first ego-centric video and applying a region-growing algorithm on the seed pixel to identify the first set of pixels that corresponds to the hand region in the image.

5. The method of claim 4, wherein the analyzing the hand gesture comprises:
comparing, by the processor, one or more pairs of the first video frame and a second video frame to calculate a motion vector for each one of the plurality of pixels to generate a motion vector field;
identifying, by the processor, one or more motion vectors from the motion vector field that are above a threshold; and
identifying, by the processor, the seed pixel from a second set of pixels associated with the one or more motion vectors that are above the threshold.

6. The method of claim 1, wherein the hand gesture comprises placing the hand within an overlay region of a display of the head-mounted video device, wherein a second set of pixels within the overlay region corresponds to the first set of pixels of the hand region.

7. The method of claim 1, wherein the hand gesture comprises:
requesting, by the processor, the hand to be placed in front of a camera of the head-mounted device capturing the first ego-centric video;
presenting, by the processor, a marker over the hand in a display of the head-mounted video device; and
prompting, by the processor, the first user to move around the hand or a head of the first user so that the marker travels within the hand that is displayed, wherein a second set of pixels traversed by the marker is defined to be the first set of pixels of the hand region.

8. The method of claim 4, wherein the region-growing algorithm comprises:
selecting, by the processor, a first region that includes the seed pixel and one or more neighboring pixels to compare a characteristic of the one or more neighboring pixels to the seed pixel, wherein the one or more neighboring pixels comprise pixels that are next to the seed pixel;
including, by the processor, the one or more neighboring pixels within the first region, wherein a characteristic of the one or more neighboring pixels matches a characteristic of the seed pixel; and
repeating, by the processor, the selecting and the including with a second region that is larger than the first region until the characteristic of the one or more neighboring pixels does not match the characteristic of pixels in the first region.

9. The method of claim 8, wherein the characteristic is a color represented by an n-dimensional vector, wherein n represents a number of dimensions, and a match is detected between n-dimensional vectors of two pixels that have an n-dimensional distance, wherein n represents a number of dimensions, that is less than a threshold.

10. The method of claim 9, wherein a distance metric for the n-dimensional distance is calculated by applying one of an Euclidean distance, a Mahanalobis, an L1-norm, an L0-norm or an inner product.

11. The method of claim 9, wherein the color comprises at least one of a red, green, blue color space, a lightness and color opponent dimensions (LAB) color space, an hue saturation value color space, a chroma (Y) and two chrominance components (UV) color space, an lightness, chroma and hue color space or a luma (Y), blue difference chroma (Cb) and red-difference chroma (Cr) color space.

12. The method of claim 1, wherein the training the head-mounted video device to detect the hand comprises identifying how the first set of pixels in the hand region that represents the hand are distributed in a statistical model.

13. The method of claim 12, wherein the statistical model comprises a Gaussian mixture model.

14. The method of claim 1, wherein the training the head-mounted video device to detect the hand comprises deriving a classifier that distinguishes the first set of pixels in the hand region from non-hand pixels in a feature space selected from a plurality of feature spaces comprising at least one of: a 3-dimensional color representation, a 1-dimensional luminance representation or a multi-dimensional texture feature.

15. (canceled)

16. The method of claim 12, wherein a feature space that includes the first set of pixels comprises an n-dimensional vector representing one or more of a brightness, a color, a hue or a texture.

17. The method of claim 1, wherein the prompting, the capturing the first ego-centric video, the analyzing, the generating and the training the head-mounted video device are repeated when the first user enters from one room to another room, the first user wears an accessory on the hand or a second user wears the head-mounted video device.

18. The method of claim 1, further comprising a verification process, the verification process comprising:
displaying, by the processor, the hand region that is detected; and
receiving, by the processor, a confirmation that the hand region is detected based on the hand region that is displayed to the first user.

19. A non-transitory computer-readable medium storing a plurality of instructions which, when executed by a processor, cause the processor to perform operations for training hand detection in a first ego-centric video, the operations comprising:
prompting a first user to provide a hand gesture, wherein the first user is wearing a head-mounted video device;
capturing the first ego-centric video containing the hand gesture via the head-mounted video device worn by the first user, wherein the first ego-centric video comprises a video that is captured from a perspective of the first user wearing the head-mounted video device;
analyzing the hand gesture in a frame of the first ego-centric video to identify a first set of pixels that corresponds to a hand region in an image;
generating a training set of features from the first set of pixels that corresponds to the hand region; and
training the head-mounted video device to detect a hand in a second ego-centric video captured after the first ego-centric video based on the training set of features.

20. An apparatus for training hand detection in a first ego-centric video comprising:
a processor; and
a computer readable medium storing a plurality of instructions which, when executed by the processor, cause the processor to perform operations, the operations comprising:
prompting a first user to provide a hand gesture, wherein the first user is wearing a head-mounted video device;
capturing the first ego-centric video containing the hand gesture via the head-mounted video device worn by the first user, wherein the first ego-centric video comprises a video that is captured from a perspective of the first user wearing the head-mounted video device;
analyzing the hand gesture in a frame of the first ego-centric video to identify a set of pixels that correspond to a hand region in an image;
generating a training set of features from the set of pixels that corresponds to the hand region; and
training the head-mounted video device to detect a hand in a second ego-centric video captured after the first ego-centric video based on the training set of features.
